(19) United States
(12) Patent Application Publication
(10) Pub. No.: US 2002/0001509 A1
(43) Pub. Date: Jan. 3, 2002

(54) Block retaining wall structure and setback locator therefor

(76) Inventor: Sung-min Hong, Seongnam city (KR)

Correspondence Address: LARSON & TAYLOR, PLC, 1199 NORTH FAIRFAX STREET, SUITE 900, ALEXANDRIA, VA, 22314, US

(21) Appl. No.: 09/891,244

(22) Filed: Jun. 27, 2001

(30) Foreign Application Priority Data
Jun. 29, 2000 (KR) 2000-36353
Jun. 19, 2001 (KR) 2001-34734

(51) Int. Cl. E02D 5/20; E04B 1/04; G01B 5/16

(52) U.S. Cl. 405/286; 52/604; 52/606; 33/518

(57) ABSTRACT

Disclosed are a block retaining wall structure having a plurality of blocks stacked each other, and an setback locator therefor. The block retaining wall structure comprises at least one pillar-accommodating hole formed on each block along stacking direction of the blocks; at least one head-accommodating hole depressed along the stacking direction of the blocks, so as to correspond to the pillar-accommodating hole; and an setback locator including a pillar part taking a bar shape, being inserted into the pillar-accommodating hole, and a head part formed at one end of the pillar part and accommodated in the head-accommodating hole, and having a plurality of contact faces having different radial contact distances from an axial line of the pillar part to an inner wall face of the head-accommodating hole. With this configuration, a retaining wall having a variety of batter angles can be selectively constructed.

### BACKGROUND OF THE INVENTION

1. Field of the Invention

The present invention relates in general to a block retaining wall structure having a plurality of blocks stacked each other and a setback locator therefor, and more particularly to a block retaining wall structure having a plurality of blocks stacked each other and an interlocking setback therefor, wherein an batter angle of the retaining wall can be selected in a various manner as desired.

2. Description of the Related Art

As well known to those skilled in the art, a block retaining wall is usually used in a wide variety of civil engineering and landscaping applications, for example to support slopes and embankments for highways, etc. The block retaining wall is constructed by a plurality of blocks staked each other.

Such a retaining wall block has been disclosed in U.S. Pat. Nos. 3,783,566 and 4,802,320, etc.

In a conventional block retaining wall, the blocks are arranged horizontally, and then stacked sequentially thereon. In order to interlock the blocks stacked vertically, bar-shaped pins are inserted through openings formed on the blocks arranged vertically. These pins usually serve to allow the blocks to maintain vertical walls, and restrict a lateral movement between the blocks, to thereby prevent the retaining wall from being deformed or collapsed.

However, in the conventional blocks for the retaining wall, shapes of pins and positions of openings formed on the blocks have been predetermined, and therefore, it has been unable to select the batter angle of the retaining wall adaptively as desired. In other words, in order to produce a retaining wall inclined at an arbitrary angle, new blocks having pin-accommodating openings whose positions are set, depending upon the selected batter angle, are to be manufactured. Therefore, using the conventional retaining wall blocks, a various type of blocks as many as possible, corresponding to the desired inclination angles of the retaining wall are needed.

### SUMMARY OF THE INVENTION

Therefore, the present invention has been made in view of the above problems, and it is an object of the present invention to provide a block retaining wall structure and a setback locator therefor, wherein the retaining walls can be constructed selectively at a variety of batter angles thereof, by means of a single type of blocks.

This and other objects of the present invention may be accomplished by the provision of a block retaining wall structure having a plurality of blocks stacked each other, comprising: at least one locator's pillar-accommodating hole formed on each block along a staking direction of the blocks; at least one locator's head-accommodating hole depressed along the stacking direction of the blocks, so as to correspond to the pillar-accommodating hole of adjacent blocks; and an setback locator including a pillar part taking a bar shape, being inserted into the pillar-accommodating hole of the block, and a locator head part formed at one end of the pillar part and accommodated in the head-accommodating hole so as to contact at least one inner wall face of the head-accommodating hole, and having a plurality of contact faces having different radial contact distances from an axial line of the pillar part to an inner wall face of the head-accommodating hole.

Here, the pillar-accommodating hole and the head-accommodating hole of each block are in communication with each other along the stacking direction.

Preferably, the pillar-accommodating hole, the head-accommodating hole and the pillar part of locator respectively have a polygonal sectional shape.

In case that the head-accommodating hole is in the shape of a groove formed horizontally relative to the block, when the blocks are alternately stacked in the horizontal direction, the displacement between the blocks 210 stacked each other can be arbitrarily selected as necessary.

Further, the present invention provides an interlocking setback locator for a block retaining wall structure.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a retaining wall block according to a first embodiment of the present invention;

FIG. 2 is a sectional view of FIG. 1 taken along line II-II;

FIG. 3 is a perspective view of a setback locator for interlocking the blocks according to one embodiment of the present invention;

FIG. 4 is a bottom view of FIG. 3;

FIG. 5 is a perspective view showing a first coupling state in which a block is coupled with the setback locators according to the present invention;

FIG. 6 is a top view of FIG. 5;

FIG. 7 is a perspective view of a block retaining wall structure according to one embodiment of the present invention, using the first coupling state of the block and the setback locator shown in FIG. 5;

FIG. 8 is a longitudinal sectional view of FIG. 7;

FIG. 9 is a perspective view showing a second coupling state in which a block is coupled with the setback locators according to the present invention;

FIG. 10 is a top view of FIG. 9;

FIG. 11 is a perspective view of a block retaining wall structure according to another embodiment of the present invention, using the second coupling state of the block and the setback locators shown in FIG. 9;

FIG. 12 is a longitudinal sectional view of FIG. 11;

FIG. 13 is a sectional view showing an installation of the retaining wall shown in FIG. 11;

FIG. 14 a perspective view of a retaining wall block according to a second embodiment of the present invention;

FIG. 15 is a sectional view of FIG. 14 taken along line XV-XV;

FIG. 16 is a perspective view of a retaining wall block according to a third embodiment of the present invention;

FIG. 17 is a sectional view of FIG. 16 taken along line XVII-XVII; and

FIG. 18 is a top view of the block retaining wall structure having a batter angle allowing the front portion to be curved, constructed with the blocks according to the present invention.

### DETAILED DESCRIPTION OF THE PREFERRED EMBODIMENT

A preferred embodiment of the present invention will be described in more detail with reference to the accompanying drawings.

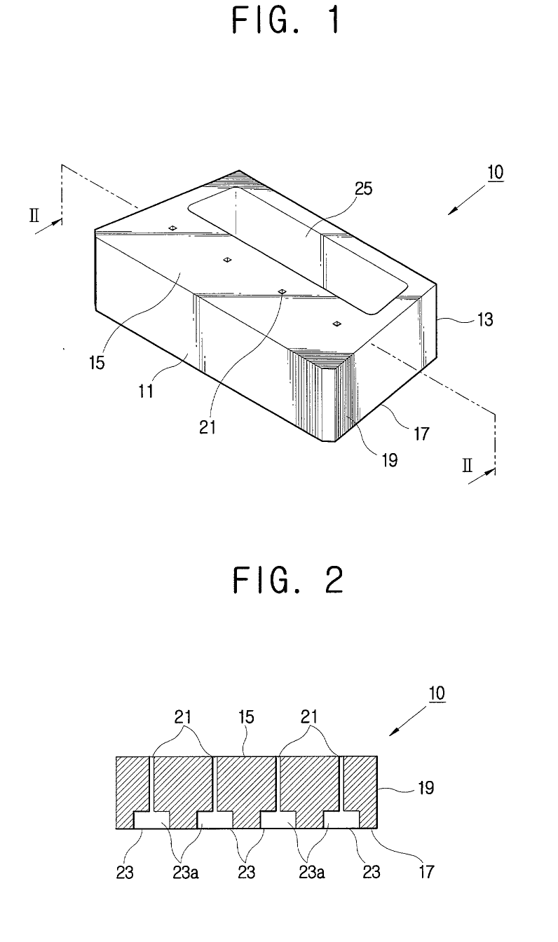

FIG. 1 is a perspective view of a retaining wall block according to a first embodiment of the present invention, and FIG. 2 is a sectional view of FIG. 1 taken along line II-II. As illustrated in these figures, blocks to constitute a retaining wall, being stacked each other, are in the form of hexahedron, having approximately a trapezoid planar shape. The block is comprised of a front face 11, a rear face opposite to the front face 11, a top face 15, a bottom face 17 and side faces 19. The horizontal length of the rear face 13 is shorter than that of the front face 11, so that retaining walls having forwardly or backwardly curved shapes can be formed in a various manner. Here, the planar shape of the block 10 can be formed variously as necessary.

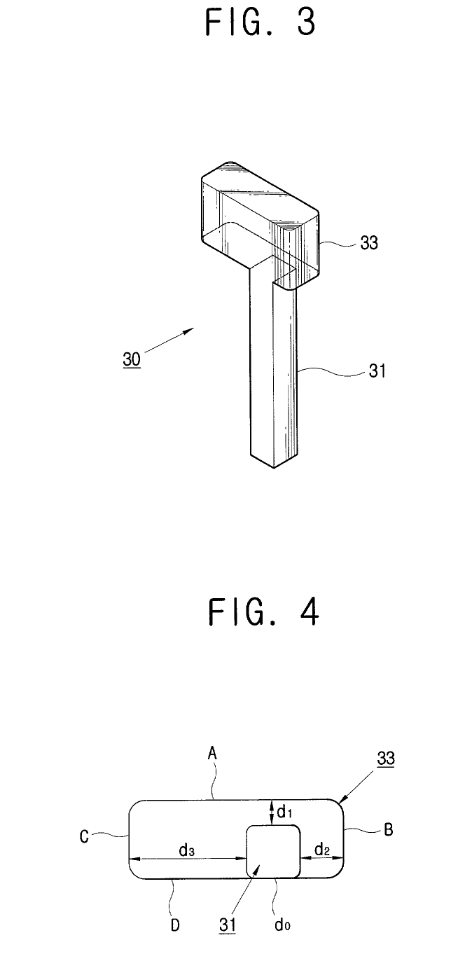

In each block are provided a plurality of the pillar-accommodating holes 21 formed downward from the top face 15, in a stacking direction. Pillar parts 31 (see FIG. 3) of setback locators 30 to be described later are inserted into these pillar-accommodating holes 21. The pillar-accommodating holes 21 are arranged horizontally at a predetermined interval. The pillar-accommodating hole 21 is rectangular in its section, corresponding to the sectional shape of the pillar part 31 of the setback locator 30. Here, the pillar-accommodating hole 21 may have a variety of sectional shapes including triangle, polygons such as pentagon or circle, in accordance with the sectional shape of the pillar part 31 of the interlocking pin.

On the lower face 17 of the block 10 are provided a plurality of head-accommodating holes 23 depressed from the lower face 17, corresponding to the pillar-accommodating holes 21 on a top face of an adjacent block. The head-accommodating holes 23 accommodate therein head parts 33 (see FIG. 3) of the setback locators 30 to be described later. The head-accommodating holes 23 is eccentrically placed forwardly relative to an axial line of the pillar-accommodating holes 21. The head-accommodating hole 23 communicates with the pillar-accommodating hole 21 so as to make a rear wall faces 23 within the head-accommodating hole 23 meet a rear wall face within the pillar-accommodating holes 21, wherein a contact face of the head part 33 of the setback locator 30 is in contact with the rear wall face 23a playing a role as a reference face for installing blocks stacked each other. The head-accommodating hole 23 is rectangular in its section.

Between the pillar-accommodating hole 21 and the head-accommodating hole 23, and the rear face 13 of the block 10 is provided an opening 25 vertically penetrating through the block 10 from the top face 15 to the lower face 17 of the block 10. The opening 25 serves to reduce a weight of the block 10, and may be filled with mortar or aggregate and/or earth and sand under the state that the blocks are stacked each other.

FIG. 3 is a perspective view of an setback locator for the blocks according to one embodiment of the present invention, and FIG. 4 is a bottom view of FIG. 3. As depicted in these figures, the setback locator 30 for the block retaining wall structure according to the present invention is comprised of the pillar part 31 taking a bar shape, which is inserted into the pillar-accommodating hole 21 of the block 10, and the head part 33 formed at one end of the pin part 31 and accommodated in the head-accommodating hole 23 so as to allow it to contact at least one inner wall face of the head-accommodating hole 23 of the block 10. The head part 33 includes a plurality of contact faces having different radial contact distances from the axial line of the pillar part 31 to an inner wall face of the head-accommodating hole 23, that is, having different distances protruding in the radial direction. The setback locator 30 is made of metal, plastic or concrete molding which can be molded in an easy manner and have a sufficient shear strength.

The pillar part 31 is rectangular in its section, corresponding to the pillar-accommodating hole 21 of the block 10. Here, the pillar part 31 have a variety of sectional shapes including triangle, polygons such as pentagon or circle, in accordance with the sectional shape of the pin-accommodating parts 31 of the block 10.

The locator head part 33 has a sectional area larger than that of the pillar part 31. As shown in FIG. 4, the locator head part 33 is rectangular in its section and has 4 different patterns in radially protruding distances relative to the axial line of the pin part 31. The face denoted D of the locator head 33, which refers to a face of meeting one side of the locator head part 33 upwardly and vertically extended from one side of the pillar part 31, has a protruding distance equal to 0 or close to 0 (d₀), the other sides denoted A, B and C are structured to have successively incremental values of distances, that is, d₁<d₂<d₃. The block retaining wall structure installed by means of blocks and setback locators according to one embodiment of the present invention will be described with reference to the accompanying drawings.

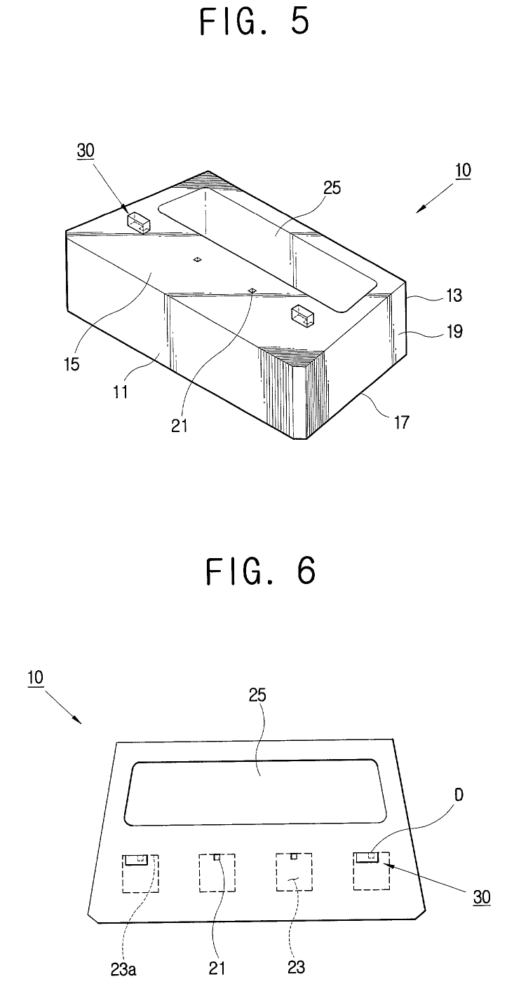

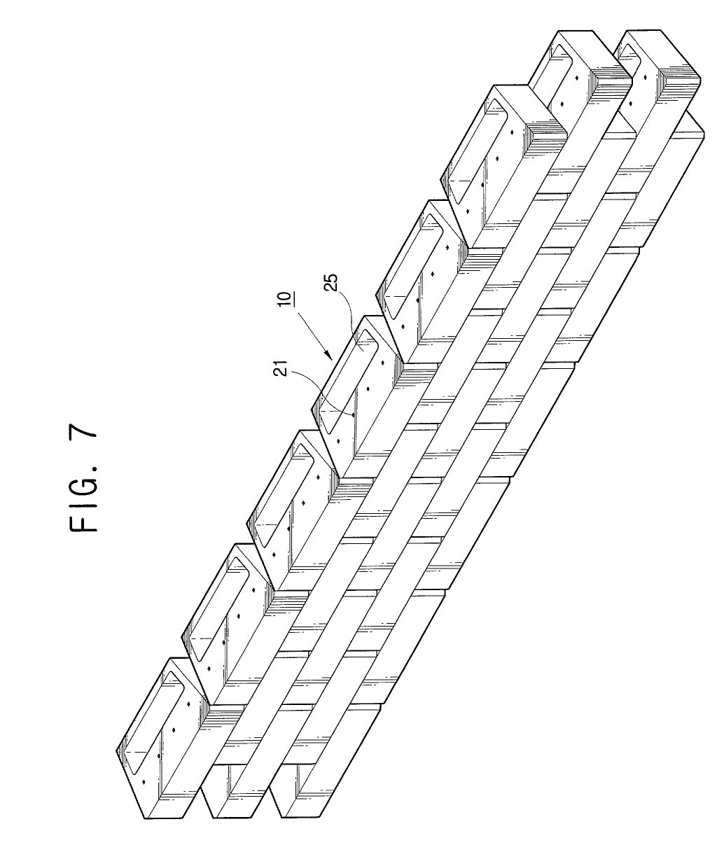

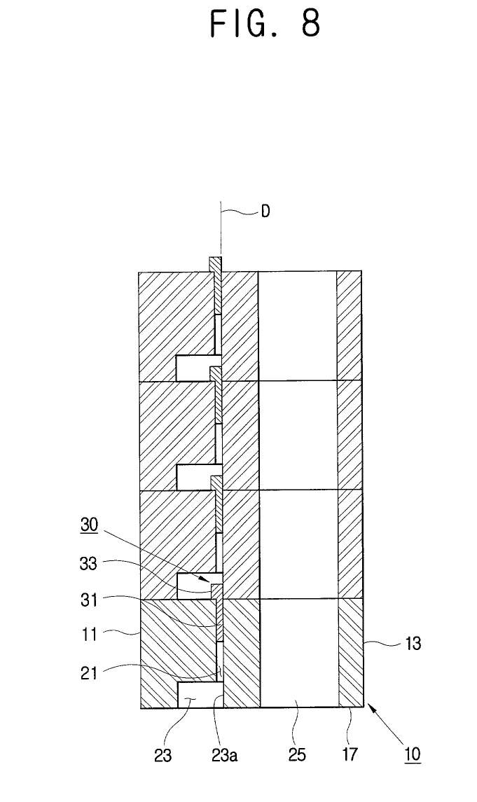

FIG. 5 is a perspective view showing a first coupling state in which a block is coupled with the setback locators according to the present invention, FIG. 6 is a top view of FIG. 5, FIG. 7 is a perspective view of a block retaining wall structure according to one embodiment of the present invention, using the first coupling state of the block and the setback locators shown in FIG. 5, and FIG. 8 is a longitudinal sectional view of FIG. 7. As illustrated therein, when the setback locator 30 is inserted into the pillar-accommodating part 21 of the block 10, a face (“D” of FIG. 4) meeting one side of the locator head part 33 vertically and upwardly extended from one side of the pillar part, which is a contact face meeting the installation reference face of the head-accommodating part 23 of the block 10, that is, one side of the locator head part 33 having a distance equal to 0 (d₀ of FIG. 4) from the upper side extended vertically from one side of the pillar part 31, is installed so as to be directed to the rear of the block 10. Then, the block is stacked so as to allow the contact face of the head part 33 on the block coupled with the setback locator to contact the installation reference face 23a of the head-accommodating hole 23. The pillar-accommodating parts 21 of each block 10 are disposed at a predetermined interval, so that the blocks may be alternately stacked each other, so as to allow the blocks 10 to be maintained horizontally at a regular interval. If the blocks are stacked upwardly, following the above-described method, the distance between the front or rear faces of the adjacent blocks is nearly zero, so that they can be positioned vertically. Therefore, the stacked blocks 10 form a vertical retaining wall structure. The openings 25 formed on the stacked blocks may be filled with mortar or aggregate, and/or earth and sand, so that the blocks are firmly coupled to each other, thereby producing a strong retaining wall structure capable of preventing collapse of the earth and sand. This vertical retaining wall structure may be used in a place which is relatively low in height and relatively small in resistance required against earth pressure.

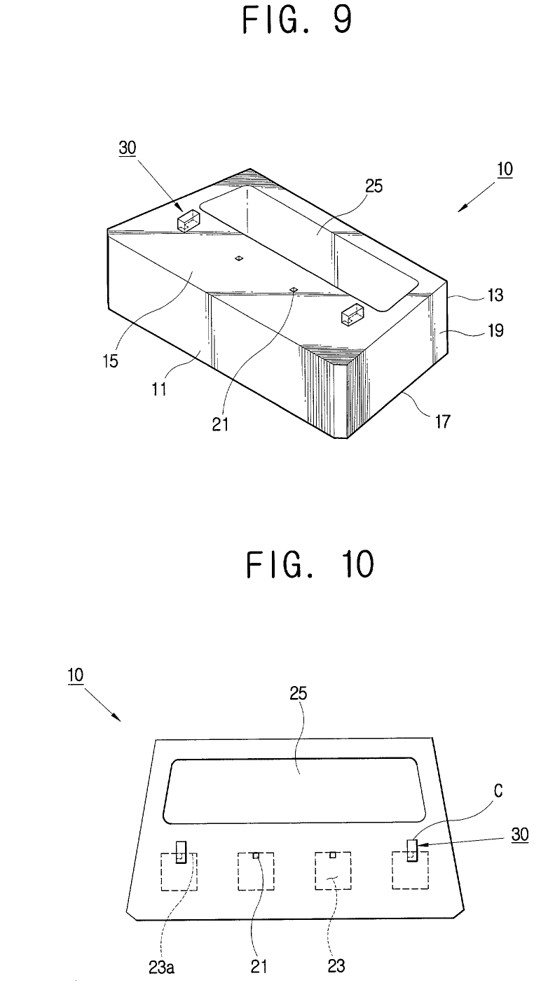

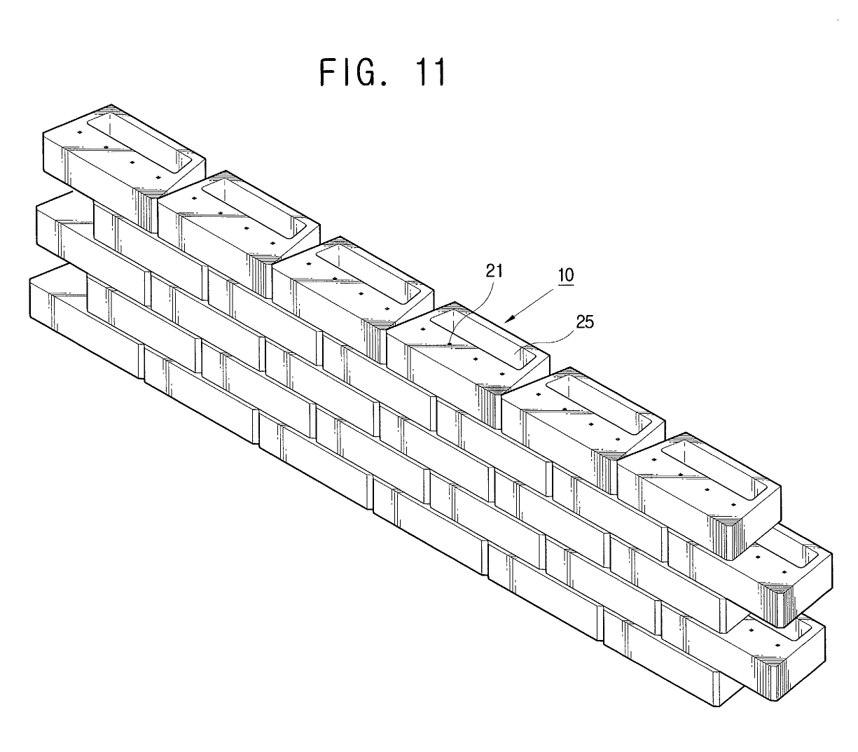

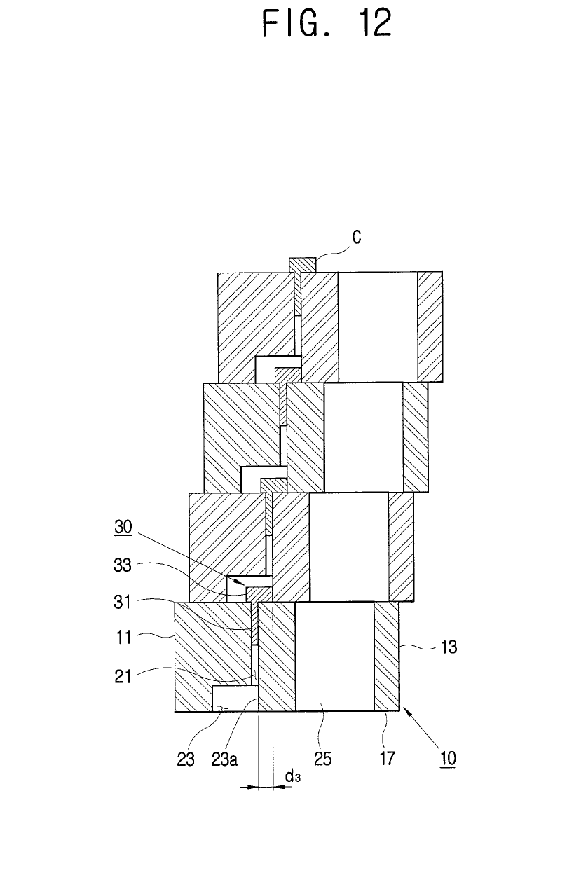

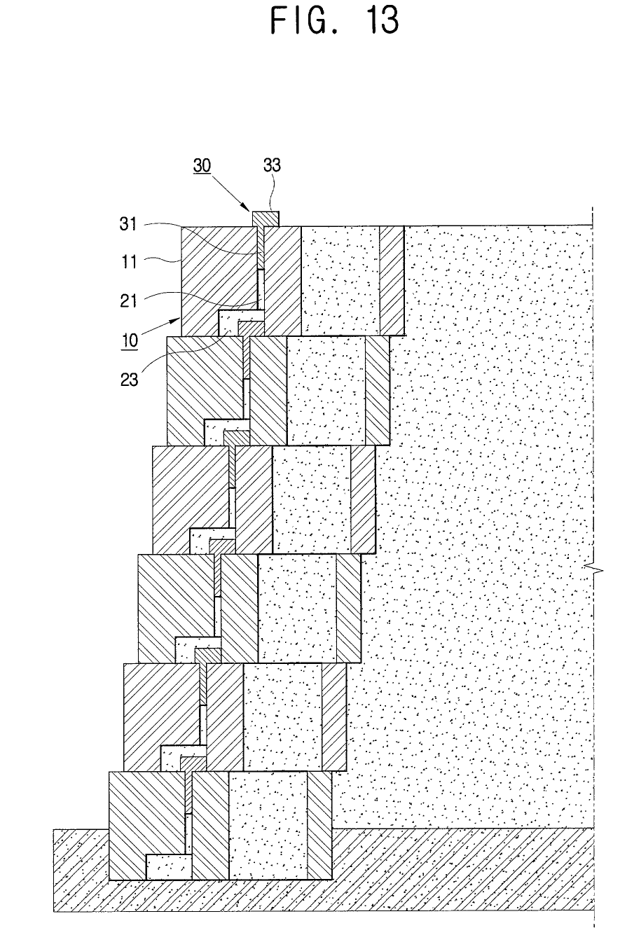

FIG. 9 is a perspective view showing a second coupling state in which a block is coupled with the setback locators according to the present invention, FIG. 10 is a top view of FIG. 9, FIG. 11 is a perspective view of a block retaining wall structure according to another embodiment of the present invention, using the second coupling state of the block and the setback locators shown in FIG. 9, FIG. 12 is a longitudinal sectional view of FIG. 11, and FIG. 13 is a sectional view showing an installation of the retaining wall shown in FIG. 11. As depicted in these Figures, when coupling the setback locator 30 with the pillar-accommodating hole 21 of the block 10, one side of the locator head part 33 (“C” of FIG. 4), separated by d₃ from the upper vertical extension of one side of the pillar part 31, as a contact face contacting the installation reference face of the head-accommodating hole 23 of the block 10, is installed so as to be directed to the rear of the block 10. Then, the blocks 10 are stacked so as to allow the contact face of the locator head part 33 on the block coupled with the setback locator to contact the installation reference face 23a of the head-accommodating hole 23. Since the pillar-accommodating parts 21 of each block 10 are maintained at regular interval, the blocks may be alternately stacked each other. If the blocks are stacked vertically, following the above-described method, the block disposed above is backwardly disposed by a distance of d₃ relative to the block disposed below, thereby forming a step. Therefore, the stacked blocks 10 form a retaining wall structure inclined vertically at a predetermined angle. As illustrated in FIG. 13, the blocks 10 are buried below the surface of the earth, and the openings 25 formed on the blocks stacked in the step structure are filled with mortar or aggregate, and/or earth and sand, so that the blocks are firmly coupled to each other, thereby producing a strong retaining wall structure capable of preventing collapse of the earth and sand. This vertical retaining wall structure may be used in a occasion which is relatively high in height and relatively great in resistance required against earth pressure.

Although it has not been shown in the accompanying drawings, according to another embodiment with respect to coupling of the block 10 and the setback locator 30 according to the present invention, when coupling the setback locator 30 with the pillar-accommodating hole 21 of the block 10, one side of the head part 33 (“A” or “B” of FIG. 4), separated by d₁ or d₂ from the upper vertical extension of one side of the pillar part 31, as a contact face contacting the installation reference face of the head-accommodating hole 23 of the block 10, may be installed so as to be directed to the rear of the block 10. Then, the blocks 10 are stacked so as to allow the contact face of the locator head part 33 on the block coupled with the setback locator to contact the installation reference face 23a of the head-accommodating hole 23. As described above, since the pillar-accommodating parts 21 of each block 10 are maintained at regular interval, the blocks may be alternately stacked on each other, so as to allow the upwardly stacked block 10 to be displaced backwardly by d₁ or d₂ relative to the lower layer block 10, thereby forming a step. In this manner, the stacked blocks 10 can form a retaining wall structure inclined vertically at a variety of angles.

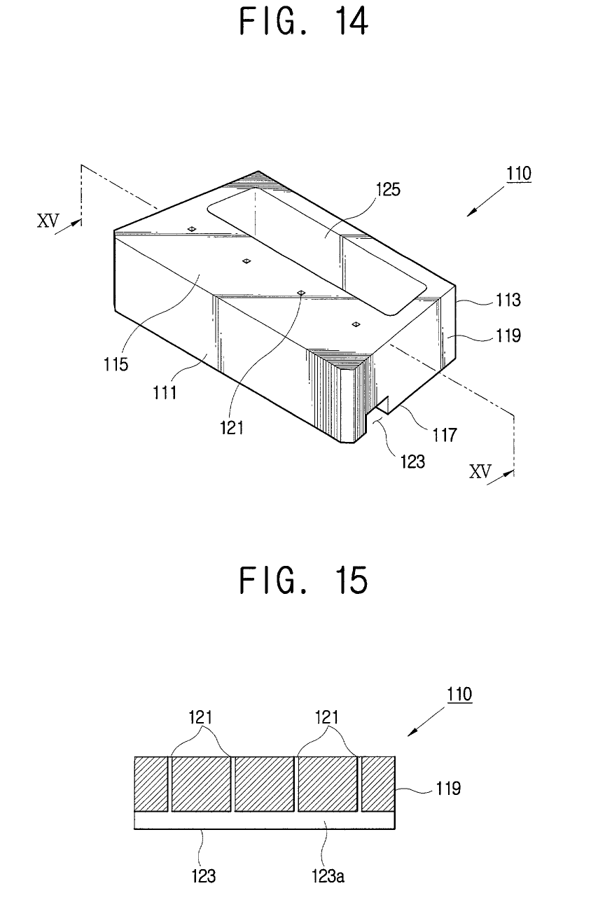

On the other hand, FIG. 14 a perspective view of a retaining wall block according to a second embodiment of the present invention, and FIG. 15 is a sectional view of FIG. 14 taken along line XV-XV. As shown in these Figures, a locator head-accommodating hole 123 is in the shape of a groove, being formed horizontally relative to a block 110, differently from the above-described embodiments.

With this configuration, when the blocks 110 are alternately stacked in the horizontal direction, while the displacement between the blocks 110 stacked each other can be maintained in a constant manner.

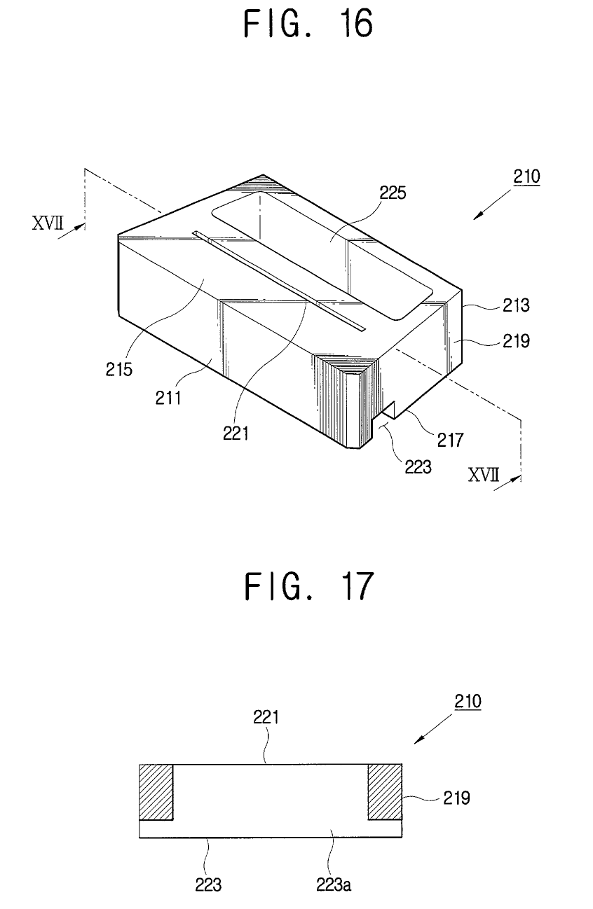

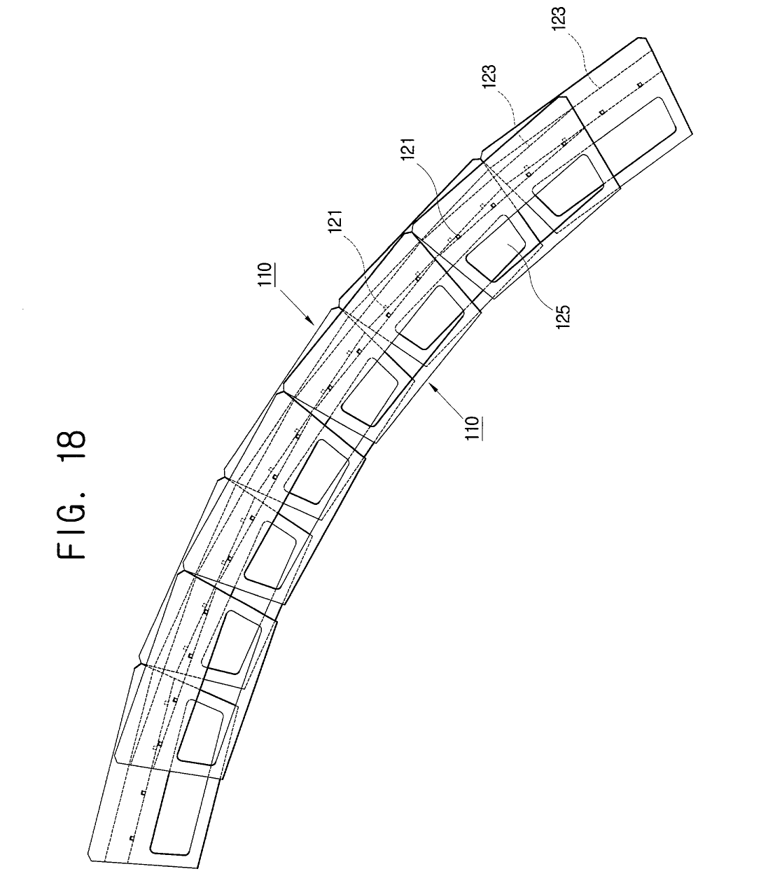

FIG. 16 is a perspective view of a retaining wall block according to a third embodiment of the present invention, and FIG. 17 is a sectional view of FIG. 16 taken along line XVII-XVII. As depicted therein, a pillar-accommodating hole 221 is in the shape of a groove formed horizontally relative to a block 210, different from the above-described embodiments. A locator head-accommodating hole 223 is also in the shape of a groove formed horizontally relative to the block 210.

With this configuration, when the blocks 210 are alternately stacked in the horizontal direction, the displacement between the blocks 210 stacked each other can be arbitrarily selected as necessary.

FIG. 18 is a top view of the block retaining wall structure having an inclination angle allowing the front portion to be curved, constructed with the blocks according to the present invention. As shown therein, it is possible to form a curved wall curved backwardly through the blocks 110 according to the present invention, having a trapezoid shape in section, in which the length of the rear face is shorter than that of the front face. In addition, since the positions and methods of coupling the blocks 110 and the setback locators 30 can be selected by a user in a various manner, a variety of curved walls can be produced; and a variety of contacting states between the contact face of the locator head part 33 of the setback locator 30 and the installation reference face of the head-accommodating hole 123 of the block 110 can be obtained, to thereby obtain a variety of batter walls.

As described above, according to the present invention, there are provided the block including the pillar-accommodating hole formed along the block-stacked direction, the head-accommodating hole depressed opposite to the pillar-accommodating hole, and the setback locator including the plurality of contact faces having different radial contact distances from the axial line of the pillar part to the installation reference face of the head-accommodating hole, which is inserted into the pillar accommodating hole so as to contact the installation reference face of the head-accommodating hole; with this configuration, coupling positions of the blocks and the setback locators can be arbitrary selected when stacking the blocks each other, thereby being able to arrange the stacked blocks horizontally in an easy manner.

Further, since the coupling direction of blocks and the setback locators are arbitrarily selected, that is, the contact face of the head part of the setback locator contacts the installation reference face of the head-accommodating hole of the block in a various manner, the user can select the batter angle for installation of the blocks stacked each other as desired.

In the above-described embodiments, the head-accommodating hole of the block and the head part of the setback locator have been limited to be rectangular in its sectional shape for the sake of convenience; however, they have a variety of sectional shapes including triangle, polygon such as pentagon, circle, cross-shape and L-shape, etc.

In the above-described embodiments, it was also described that the installation reference face of the head-accommodating hole is identical to the rear face of the pillar-accommodating hole and the pillar-accommodating hole communicates with the head-accommodating hole; however, the installation reference face of the head-accommodating hole may not be identical to the rear face of the pillar-accommodating hole and the pillar-accommodating hole may not communicate with the head-accommodating hole.

Preferably, corners of the blocks in the above-described embodiments are chamfered off, to make it convenient to construct a curved wall.

As apparent from the above description, the present invention provides a block retaining wall structure and an setback locator therefor, wherein a coupling direction of the block and the setback locator is selected by means of a single type of block and a setback locator so as to stack the blocks each other, thereby selectively constructing a retaining wall having a variety of batter angles.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. A block retaining wall structure having a plurality of blocks stacked each other, comprising:
at least one locator's pillar-accommodating hole formed on each block along a staking direction of the blocks;
at least one locator's head-accommodating hole depressed along the stacking direction of the blocks, so as to correspond to the pillar-accommodating hole of adjacent blocks; and
an setback locator including a pillar part taking a bar shape, being inserted into the pillar-accommodating hole of the block, and a head part formed at one end of the pillar part and accommodated in the head-accommodating hole so as to contact at least one inner wall face of the head-accommodating hole, and having a plurality of contact faces having different radial contact distances from an axial line of the pillar part to an inner wall face of the head-accommodating hole.

2. The block retaining wall structure as set forth in claim 1, wherein the pillar-accommodating hole and the head-accommodating hole of each block are in communication with each other along the stacking direction.

3. The block retaining wall structure as set forth in claim 1, wherein the pillar-accommodating hole, the head-accommodating hole and the pillar part respectively have a polygonal sectional shape.

4. The block retaining wall structure as set forth in claim 1, wherein the pillar-accommodating hole is in the shape of a groove formed horizontally relative to the block.

5. An setback locator for a block retaining wall structure, comprising:
a pillar part taking a bar shape; and
a head part formed at one end of the pillar part, having a plurality of contact faces having different radial contact distances.
